(19) United States
(12) Patent Application Publication
(10) Pub. No.: US 2020/0160341 A1
(43) Pub. Date: May 21, 2020

(54) System, Computer Program Product, and Method for Authorization Rate Prediction

(71) Applicant: Visa International Service Association, San Francisco, CA (US)

(72) Inventors: Shaik Khadar Habeeb, Chittoor (IN); Vinod Kumar Pinniboyina, Bangalore (IN); Mohan Babu Nellore, Bangalore (IN)

(21) Appl. No.: 16/192,986

(22) Filed: Nov. 16, 2018

(51) Int. Cl. G06Q 20/40; G06Q 20/34; G06Q 20/20

(52) U.S. Cl. CPC G06Q 20/409; G06Q 20/204; G06Q 20/341

(57) ABSTRACT

Provided is a system for predicting authorization of a payment transaction that includes at least one processor programmed or configured to receive electronic payment card data associated with an electronic payment card involved in a payment transaction, determine an authorization rate associated with an application of the electronic payment card based on the electronic payment card data associated with the electronic payment card, determine whether to communicate an authorization request message for the payment transaction based on the authorization rate associated with the application of the electronic payment card, communicate the authorization request message based on determining to communicate the authorization request, and determine to authorize the payment transaction based on an authorization response message. A computer program product and method are also disclosed.

### BACKGROUND

### 1. Field of the Disclosure

This disclosure relates generally to systems, devices, products, apparatus, and methods that are used for determining a metric associated with authorization of a payment transaction, in one particular embodiment, to a system, product, and method for predicting authorization of a payment transaction conducted using an electronic payment card.

### 2. Technical Considerations

An electronic payment card (e.g., a smart card, a chip card, and/or the like), may include a pocket-sized card that has embedded integrated circuits. An electronic payment card may include a pattern of metal contacts to electrically connect to an internal chip and the metal contacts may be used to communicate information based on physical contact. In some instances, an electronic payment card may be used to communicate data associated with personal identification, authentication, data storage, and application processing. For example, the electronic payment card may be used to communicate data associated with an account identifier of an account that is associated with the electronic payment card. The data associated with the account identifier of the account may be stored in a memory of the electronic payment card.

However, an electronic payment card may be used during a payment transaction. For example, a card present payment transaction and a merchant system that is involved in the payment transaction may not be able to determine whether the payment transaction is likely to be authorized (e.g., by an issuer that issued the account associated with the electronic payment card) based on the data communicated by the electronic payment card. In such an example, the merchant system may process the payment transaction and the payment transaction may not be authorized by an issuer that issued the account associated with the electronic payment card. This may result in a merchant associated with the merchant system incurring a cost associated with processing the payment transaction that is not authorized. Additionally, by processing the payment transaction, the merchant system may unnecessarily increase a number of messages (e.g., authorization request messages, authorization response message, and/or the like) that are communicated in a payment processing network.

### SUMMARY

Accordingly, systems, devices, products, apparatus, and/or methods for predicting authorization of a payment transaction conducted using an electronic payment card are disclosed that overcome some or all of the deficiencies of the prior art.

According to a non-limiting embodiment, provided is a system for predicting authorization of a payment transaction conducted using an electronic payment card. The system comprises at least one processor programmed or configured to: receive electronic payment card data associated with an electronic payment card involved in a payment transaction; determine an authorization rate associated with an application of the electronic payment card based on the electronic payment card data associated with an electronic payment card; determine whether to communicate an authorization request message for the payment transaction based on the authorization rate associated with the application of the electronic payment card; communicate the authorization request message based on determining to communicate the authorization request; and determine to authorize the payment transaction based on an authorization response message.

According to another non-limiting embodiment, provided is a computer program product for predicting authorization of a payment transaction. The computer program product comprises at least one non-transitory computer-readable medium including one or more instructions that, when executed by at least one processor, cause the at least one processor to: receive electronic payment card data associated with an electronic payment card involved in a payment transaction; determine an authorization rate associated with an application of the electronic payment card based on the electronic payment card data associated with an electronic payment card; determine whether to communicate an authorization request message for the payment transaction based on the authorization rate associated with the application of the electronic payment card; and communicate the authorization request message based on determining that the authorization rate associated with the application of the electronic payment card satisfies a threshold.

According to a further non-limiting embodiment, provided is a c computer-implemented method for predicting authorization of a payment transaction. The method comprises receiving, with at least one processor, electronic payment card data associated with an electronic payment card involved in a payment transaction; determining, with at least one processor, an authorization rate associated with an application of the electronic payment card based on the electronic payment card data associated with an electronic payment card; determining, with at least one processor, whether to communicate an authorization request message for the payment transaction based on the authorization rate associated with the application of the electronic payment card; communicating, with at least one processor, the authorization request message based on determining that the authorization rate associated with the application of the electronic payment card satisfies a threshold; and determining, with at least one processor, to authorize the payment transaction based on an authorization response message.

Further embodiments or aspects are set forth in the following numbered clauses:

Clause 1: A system for predicting authorization of a payment transaction comprising: at least one processor programmed or configured to: receive electronic payment card data associated with an electronic payment card involved in a payment transaction; determine an authorization rate associated with an application of the electronic payment card based on the electronic payment card data associated with the electronic payment card; determine whether to communicate an authorization request message for the payment transaction based on the authorization rate associated with the application of the electronic payment card; and communicate the authorization request message based on determining to communicate the authorization request; and determine to authorize the payment transaction based on an authorization response message.

Clause 2: The system of clause 1, wherein the at least one processor is further programmed or configured to: update a counter for the application of the electronic payment card, wherein the counter is stored on the electronic payment card.

Clause 3: The system of clauses 1 or 2, wherein, when updating the counter for the application of the electronic payment card, the at least one processor is programmed or configured to: communicate a script to the electronic payment card that causes an integrated circuit of the electronic payment card to update the counter for the application of the electronic payment card.

Clause 4: The system of any of clauses 1-3, wherein, when determining the authorization rate associated with the application of the electronic payment card, the at least one processor is programmed or configured to: determine an application authorization rate of payment network transactions for the application and a merchant authorization rate of payment network transactions for the application based on the electronic payment card data associated with the electronic payment card; and wherein, when determining whether to communicate the authorization request message for the payment transaction, the at least one processor is programmed or configured to: determine to communicate the authorization request message for the payment transaction based on the application authorization rate of payment network transactions for the application and the merchant authorization rate of payment network transactions for the application.

Clause 5: The system of any of clauses 1-4, wherein, when receiving the electronic payment card data associated with the electronic payment card involved in the payment transaction, the at least one processor is programmed or configured to: receive the electronic payment card data associated with the electronic payment card involved in the payment transaction from an integrated circuit of the electronic payment card.

Clause 6: The system of any of clauses 1-5, wherein the electronic payment card data comprises data associated with a plurality of counters for the application of the electronic payment card data, and wherein, when determining whether to communicate the authorization request message for the payment transaction, the at least one processor is programmed or configured to: determine the authorization rate associated with the application of the electronic payment card based on the plurality of counters for the application.

Clause 7: The system of any of clauses 1-6, wherein the at least one processor is further programmed or configured to: select the application of the electronic payment card based on determining that the application of the electronic payment card is supported by a point-of-sale (POS) device of a merchant system; and wherein, when determining the authorization rate associated with the application of the electronic payment card, the at least one processor is programmed or configured to: determine the authorization rate associated with the application of the electronic payment card based on selecting the application of the electronic payment card.

Clause 8: A computer program product for predicting authorization of a payment transaction, the computer program product comprising at least one non-transitory computer-readable medium including one or more instructions that, when executed by at least one processor, cause the at least one processor to: receive electronic payment card data associated with an electronic payment card involved in a payment transaction; determine an authorization rate associated with an application of the electronic payment card based on the electronic payment card data associated with an electronic payment card; determine whether to communicate an authorization request message for the payment transaction based on the authorization rate associated with the application of the electronic payment card; and communicate the authorization request message based on determining that the authorization rate associated with the application of the electronic payment card satisfies a threshold.

Clause 9: The computer program product of clause 8, wherein the one or more instructions further cause the at least one processor to: update a counter for the application of the electronic payment card, wherein the counter is stored on the electronic payment card.

Clause 10: The computer program product of clauses 8 or 9, wherein the one or more instructions that cause the at least one processor to update the counter for the application of the electronic payment card, cause the at least one processor to: communicate a script to the electronic payment card that causes an integrated circuit of the electronic payment card to update the counter for the application of the electronic payment card.

Clause 11: The computer program product of any of clauses 8-10, wherein the one or more instructions that cause the at least one processor to determine the authorization rate associated with the application of the electronic payment card, cause the at least one processor to: determine an application authorization rate of payment network transactions for the application and a merchant authorization rate of payment network transactions for the application based on the electronic payment card data associated with the electronic payment card; and wherein the one or more instructions that cause the at least one processor to determine whether to communicate the authorization request message for the payment transaction, cause the at least one processor to: determine to communicate the authorization request message for the payment transaction based on the application authorization rate of payment network transactions for the application and the merchant authorization rate of payment network transactions for the application.

Clause 12: The computer program product of any of clauses 8-11, wherein the one or more instructions that cause the at least one processor to receive the electronic payment card data associated with the electronic payment card involved in the payment transaction, cause the at least one processor to: receive the electronic payment card data associated with the electronic payment card involved in the payment transaction from an integrated circuit of the electronic payment card.

Clause 13: The computer program product of any of clauses 8-12, wherein the electronic payment card data comprises data associated with a plurality of counters for the application of the electronic payment card data, and wherein the one or more instructions that cause the at least one processor to determine whether to communicate the authorization request message for the payment transaction, cause the at least one processor to: determine the authorization rate associated with the application of the electronic payment card based on the plurality of counters for the application.

Clause 14: A computer-implemented method for predicting authorization of a payment transaction comprising: receiving, with at least one processor, electronic payment card data associated with an electronic payment card involved in a payment transaction; determining, with at least one processor, an authorization rate associated with an application of the electronic payment card based on the electronic payment card data associated with the electronic payment card; determining, with at least one processor, whether to communicate an authorization request message for the payment transaction based on the authorization rate associated with the application of the electronic payment card; communicating, with at least one processor, the authorization request message based on determining that the authorization rate associated with the application of the electronic payment card satisfies a threshold; and determining, with at least one processor, to authorize the payment transaction based on an authorization response message.

Clause 15: The computer-implemented method of clause 14, further comprising: updating a counter for the application of the electronic payment card, wherein the counter is stored on the electronic payment card.

Clause 16: The computer-implemented method of clauses 14 or 15, wherein updating the counter for the application of the electronic payment card comprises: communicating a script to the electronic payment card that causes an integrated circuit of the electronic payment card to update the counter for the application of the electronic payment card.

Clause 17: The computer-implemented method of any of clauses 14-16, wherein determining the authorization rate associated with the application of the electronic payment card comprises: determining an application authorization rate of payment network transactions for the application and a merchant authorization rate of payment network transactions for the application based on the electronic payment card data associated with the electronic payment card; and wherein determining whether to communicate the authorization request message for the payment transaction comprises: determining to communicate the authorization request message for the payment transaction based on the application authorization rate of payment network transactions for the application and the merchant authorization rate of payment network transactions for the application.

Clause 18: The computer-implemented method of any of clauses 14-17, wherein receiving the electronic payment card data associated with the electronic payment card involved in the payment transaction comprises: receiving the electronic payment card data associated with the electronic payment card involved in the payment transaction from an integrated circuit of the electronic payment card.

Clause 19: The computer-implemented method of any of clauses 14-18, wherein the electronic payment card data comprises data associated with a plurality of counters for the application of the electronic payment card data, and wherein determining whether to communicate the authorization request message for the payment transaction comprises: determining the authorization rate associated with the application of the electronic payment card based on the plurality of counters for the application.

Clause 20: The computer-implemented method of any of clauses 14-19, further comprising: selecting the application of the electronic payment card based on determining that the application of the electronic payment card is supported by a point-of-sale (POS) device of a merchant system; and wherein determining the authorization rate associated with the application of the electronic payment card comprises: determining the authorization rate associated with the application of the electronic payment card based on selecting the application of the electronic payment card.

These and other features and characteristics of the present disclosure, as well as the methods of operation and functions of the related elements of structures and the combination of parts and economies of manufacture, will become more apparent upon consideration of the following description and the appended claims with reference to the accompanying drawings, all of which form a part of this specification, wherein like reference numerals designate corresponding parts in the various figures. It is to be expressly understood, however, that the drawings are for the purpose of illustration and description only and are not intended as a definition of the limits of the disclosure. As used in the specification and the claims, the singular form of “a,” “an,” and “the” include plural referents unless the context clearly dictates otherwise.

### BRIEF DESCRIPTION OF THE DRAWINGS

Additional advantages and details of the disclosure are explained in greater detail below with reference to the exemplary embodiments that are illustrated in the accompanying schematic figures, in which:

FIG. 1 is a diagram of a non-limiting embodiment of an environment in which systems, devices, products, apparatus, and/or methods, described herein, may be implemented according to the principles of the present disclosure;

FIG. 2 is a diagram of a non-limiting embodiment of components of one or more devices of FIG. 1;

FIG. 3 is a flowchart of a non-limiting embodiment of a process for predicting authorization of a payment transaction conducted using an electronic payment card; and

FIGS. 4A-4D are diagrams of an implementation of a non-limiting embodiment of the process shown in FIG. 3.

### DETAILED DESCRIPTION

For purposes of the description hereinafter, the terms “end,” “upper,” “lower,” “right,” “left,” “vertical,” “horizontal,” “top,” “bottom,” “lateral,” “longitudinal,” and derivatives thereof shall relate to the disclosure as it is oriented in the drawing figures. However, it is to be understood that the disclosure may assume various alternative variations and step sequences, except where expressly specified to the contrary. It is also to be understood that the specific devices and processes illustrated in the attached drawings, and described in the following specification, are simply exemplary embodiments or aspects of the disclosure. Hence, specific dimensions and other physical characteristics related to the embodiments or aspects of the embodiments disclosed herein are not to be considered as limiting unless otherwise indicated.

No aspect, component, element, structure, act, step, function, instruction, and/or the like used herein should be construed as critical or essential unless explicitly described as such. Also, as used herein, the articles “a” and “an” are intended to include one or more items, and may be used interchangeably with “one or more” and “at least one.” Furthermore, as used herein, the term “set” is intended to include one or more items (e.g., related items, unrelated items, a combination of related and unrelated items, etc.) and may be used interchangeably with “one or more” or “at least one.” Where only one item is intended, the term “one” or similar language is used. Also, as used herein, the terms “has,” “have,” “having,” or the like are intended to be open-ended terms. Further, the phrase “based on” is intended to mean “based at least partially on” unless explicitly stated otherwise.

As used herein, the terms “communication” and “communicate” may refer to the reception, receipt, transmission, transfer, provision, and/or the like of information (e.g., data, signals, messages, instructions, commands, and/or the like). For one unit (e.g., a device, a system, a component of a device or system, combinations thereof, and/or the like) to be in communication with another unit means that the one unit is able to directly or indirectly receive information from and/or transmit information to the other unit. This may refer to a direct or indirect connection that is wired and/or wireless in nature. Additionally, two units may be in communication with each other even though the information transmitted may be modified, processed, relayed, and/or routed between the first and second unit. For example, a first unit may be in communication with a second unit even though the first unit passively receives information and does not actively transmit information to the second unit. As another example, a first unit may be in communication with a second unit if at least one intermediary unit (e.g., a third unit located between the first unit and the second unit) processes information received from the first unit and communicates the processed information to the second unit. In some non-limiting embodiments, a message may refer to a network packet (e.g., a data packet and/or the like) that includes data. It will be appreciated that numerous other arrangements are possible.

As used herein, the terms “issuer institution,” “issuer,” or “issuer bank” may refer to one or more entities that provide one or more accounts to a user (e.g., customer, consumer, and/or the like) for conducting transactions, such as credit card payment transactions and/or debit card payment transactions. For example, an issuer institution may provide an account identifier, such as a primary account number (PAN), to a user that uniquely identifies one or more accounts associated with the user (e.g., one or more accounts associated with a payment device of the user). The account identifier may be embodied on a payment device, such as a physical financial instrument (e.g., a payment card, an electronic payment card, a credit card, a debit card, and/or the like), and/or may be electronic and used for payment transactions. In some non-limiting embodiments, an issuer institution may be associated with a bank identification number (BIN) that uniquely identifies the issuer institution. As used herein, the term “issuer system” may refer to one or more computer systems operated by or on behalf of an issuer institution, such as a server computer executing one or more software applications. For example, an issuer system may include one or more authorization servers for authorizing a payment transaction.

As used herein, the term “account identifier” may refer to one or more types of identifiers associated with a user account (e.g., an account identifier, a PAN, a card number, a payment card number, a token, and/or the like). In some non-limiting embodiments, an issuer institution may provide an account identifier (e.g., a PAN, a token, and/or the like) to a user that uniquely identifies one or more accounts associated with that user. The account identifier may be embodied on a physical financial instrument (e.g., a payment device, a payment card, a credit card, a debit card, and/or the like) and/or may be electronic information communicated to the user that the user may use for payment transactions. In some non-limiting embodiments, the account identifier may be an original account identifier, where the original account identifier was provided to a user at the creation of the account associated with the account identifier. In some non-limiting embodiments, the account identifier may be an account identifier (e.g., a supplemental account identifier) that is provided to a user after the original account identifier was provided to the user. For example, if the original account identifier is forgotten, stolen, and/or the like, a supplemental account identifier may be provided to the user. In some non-limiting embodiments, an account identifier may be directly or indirectly associated with an issuer institution such that an account identifier may be a token that maps to a PAN or other type of identifier. Account identifiers may be alphanumeric, any combination of characters and/or symbols, and/or the like.

As used herein, the term “token” may refer to an identifier that is used as a substitute or replacement identifier for an account identifier, such as a PAN. A token may be used as a substitute or replacement identifier for an original account identifier, such as a PAN. Tokens may be associated with a PAN or other original account identifier in one or more data structures (e.g., one or more databases and/or the like) such that they may be used to conduct a transaction without directly using the original account identifier. In some non-limiting embodiments, an original account identifier, such as a PAN, may be associated with a plurality of tokens for different individuals or purposes. In some non-limiting embodiments, tokens may be associated with a PAN or other account identifiers in one or more data structures such that they can be used to conduct a transaction without directly using the account identifier, such as a PAN. In some examples, an account identifier, such as a PAN, may be associated with a plurality of tokens for different uses or different purposes.

As used herein, the term “merchant” may refer to one or more entities (e.g., operators of retail businesses) that provide goods and/or services, and/or access to goods and/or services, to a user based on a transaction, such as a payment transaction. As used herein, the term “merchant system” may refer to one or more computer systems operated by or on behalf of a merchant, such as a server executing one or more software applications. As used herein, the term “product” may refer to one or more goods and/or services offered by a merchant.

As used herein, the term “point-of-sale (POS) device” may refer to one or more devices, which may be used by a merchant to conduct a transaction (e.g., a payment transaction) and/or process a transaction. For example, a POS device may include one or more computers, peripheral devices, card readers, near-field communication (NFC) receivers, radio frequency identification (RFID) receivers, and/or other contactless transceivers or receivers, contact-based receivers, payment terminals, computers, servers, input devices, and/or the like.

As used herein, the term “POS system” may refer to one or more computers and/or peripheral devices used by a merchant to conduct a transaction. For example, a POS system may include one or more POS devices, and/or other like devices that may be used to conduct a payment transaction. A POS system (e.g., a merchant POS system) may also include one or more server computers programmed or configured to process online payment transactions through webpages, mobile applications, and/or the like.

As used herein, the term “transaction service provider” may refer to an entity that receives authorization request messages for payment transactions from merchants or other entities and provides guarantees of payment, in some cases through an agreement between the transaction service provider and an issuer institution. For example, a transaction service provider may include a payment network, such as Visa®, MasterCard®, American Express®, or any other entity that processes transactions. As used herein, the term “transaction service provider system” may refer to one or more computer systems operated by or on behalf of a transaction service provider, such as a transaction service provider system executing one or more software applications. A transaction service provider system may include one or more processors and, in some non-limiting embodiments, may be operated by or on behalf of a transaction service provider.

As used herein, the terms “client” and “client device” may refer to one or more computing devices, such as processors, storage devices, and/or similar computer components, that access a service made available by a server. In some non-limiting embodiments, a “client device” may refer to one or more devices that facilitate payment transactions, such as POS devices and/or POS systems used by a merchant. In some non-limiting embodiments, a client device may be any electronic device configured to communicate with one or more networks and/or initiate or facilitate transactions such as, but not limited to, one or more computers, portable computers (e.g., tablet computers), mobile devices (e.g., cellular phones, smartphones, wearable devices, such as watches, glasses, lenses, and/or clothing, PDAs, and/or the like), and/or other like devices. Moreover, a “client” may also refer to an entity, such as a merchant, that owns, utilizes, and/or operates a client device for initiating transactions with a transaction service provider.

As used herein, the term “server” may refer to one or more computing devices, such as processors, storage devices, and/or similar computer components, which communicate with client devices and/or other computing devices over a network, such as the Internet or private networks, and, in some examples, facilitate communication among other servers and/or client devices. It will be appreciated that various other arrangements are possible. As used herein, the term “system” may refer to one or more computing devices or combinations of computing devices such as, but not limited to, processors, servers, client devices, software applications, and/or other like components. In addition, reference to “a server” or “a processor,” as used herein, may refer to a previously-recited server and/or processor that is recited as performing a previous step or function, a different server and/or processor, and/or a combination of servers and/or processors. For example, as used in the specification and the claims, a first server and/or a first processor that is recited as performing a first step or function may refer to the same or different server and/or a processor recited as performing a second step or function.

Non-limiting embodiments of the present disclosure are directed to systems, methods, and computer program products for predicting authorization of a payment transaction conducted using an electronic payment card. In some non-limiting embodiments, a system includes at least one processor programmed or configured to: receive electronic payment card data associated with an electronic payment card involved in a payment transaction, determine an authorization rate associated with an application of the electronic payment card based on the electronic payment card data associated with an electronic payment card, determine whether to communicate an authorization request message for the payment transaction based on the authorization rate associated with the application of the electronic payment card, communicate the authorization request message based on determining that the authorization rate associated with the application of the electronic payment card satisfies a threshold.

In this way, embodiments of the present disclosure may prevent a merchant associated with the merchant system incurring a cost associated with processing the payment transaction that is not authorized. Additionally, embodiments of the present disclosure may decrease a number of messages (e.g., authorization request messages, authorization response message, and/or the like) that are communicated in a payment processing network and reduce network traffic and utilization of computing resources associated with processing payment transactions that are not likely to be authorized.

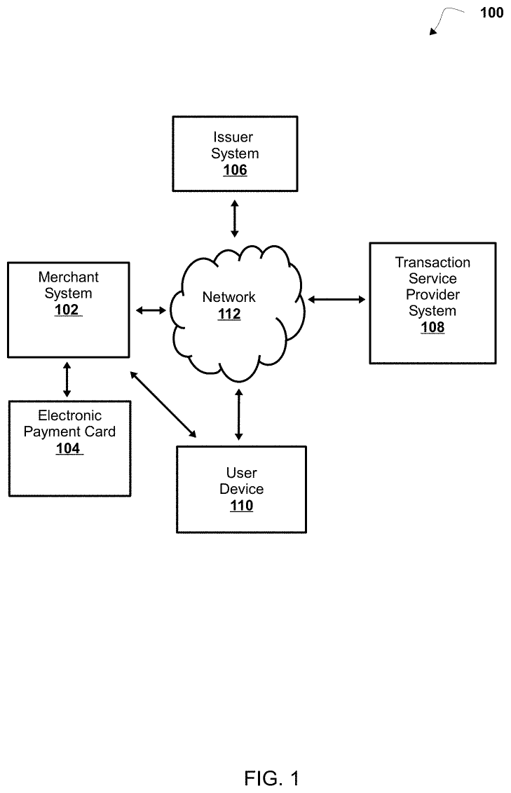

Referring now to FIG. 1, FIG. 1 is a diagram of an example environment 100 in which devices, systems, and/or methods, described herein, may be implemented. As shown in FIG. 1, environment 100 includes merchant system 102, electronic payment card 104, issuer system 106, transaction service provider system 108, user device 110, and network 112. Merchant system 102, electronic payment card 104, issuer system 106, transaction service provider system 108, and/or user device 110 may interconnect (e.g., establish a connection to communicate) via wired connections, wireless connections, or a combination of wired and wireless connections.

Merchant system 102 may include one or more devices capable of receiving information from and/or communicating information to electronic payment card 104, issuer system 106, transaction service provider system 108, user device 110 via network 112. Merchant system 102 may also include a device capable of receiving information from user device 110 via network 112, a communication connection (e.g., an NFC communication connection, an RFID communication connection, a Bluetooth® communication connection, and/or the like) with user device 110, and/or the like, and/or communicating information to user device 110 via network 112, the communication connection, and/or the like. For example, merchant system 102 may include a computing device, such as a server, a group of servers, a client device, a group of client devices, and/or other like devices. In some non-limiting embodiments, merchant system 102 may be associated with a merchant as described herein. In some non-limiting embodiments, merchant system 102 may include one or more user devices 110. For example, merchant system 102 may include user device 110 that allows a merchant to communicate information to transaction service provider system 108. In some non-limiting embodiments, merchant system 102 may include one or more devices, such as computers, computer systems, and/or peripheral devices capable of being used by a merchant to conduct a payment transaction with a user. For example, merchant system 102 may include a POS device and/or a POS system. In some non-limiting embodiments, merchant system 102 may include an application stored on a device of merchant system 102, such as a mobile application (e.g., a mobile device application, a native application for a mobile device, a mobile cloud application for a mobile device, and/or the like). In some non-limiting embodiments, the application associated with user device 110 may be operated by an entity that is the same as the entity associated with electronic payment card 104. For example, the application associated with merchant system 102 may be operated by a transaction service provider that controls a payment processing network on which electronic payment card 104 may be used or the application associated with merchant system 102 may be operated by an issuer institution that issued electronic payment card 104.

Electronic payment card 104 may include one or more devices capable of receiving information from merchant system 102 and/or user device 110 and/or communicating information to merchant system 102 and/or user device 110 via a communication connection (e.g., a wired communication connection, such as a communication connection based on an electrical connection, a wireless communication connection, such as a short range wireless communication connection, and/or the like). For example, electronic payment card 104 may include an integrated circuit to allow electronic payment card 104 to function as a contact payment card, an integrated circuit to allow electronic payment card 104 to function as a contactless payment card, or an integrated circuit to allow electronic payment card 104 to function as a combination of a contact payment card and a contactless payment card. In some non-limiting embodiments, electronic payment card 104 may be compliant with the Europay, Mastercard, Visa (EMV) standard and/or other payment processing standards. For example, electronic payment card 104 may be compliant with the EMV standard and/or electronic payment card 104 may be compliant with the Global Platform (GP) standard.

Issuer system 106 may include one or more devices capable of receiving information from and/or communicating information to merchant system 102, transaction service provider system 108, and/or user device 110 via network 112. For example, issuer system 106 may include a computing device, such as a server, a group of servers, and/or other like devices. In some non-limiting embodiments, issuer system 106 may be associated with an issuer institution as described herein. For example, issuer system 106 may be associated with an issuer institution that issued a credit account, debit account, credit card, debit card, and/or the like to a user associated with user device 110 and/or electronic payment card 104.

Transaction service provider system 108 may include one or more devices capable of receiving information from and/or communicating information to merchant system 102, issuer system 106, and/or user device 110 via network 112. For example, transaction service provider system 108 may include a computing device, such as a server (e.g., a transaction processing server), a group of servers, and/or other like devices. In some non-limiting embodiments, transaction service provider system 108 may be associated with a transaction service provider as described herein. In some non-limiting embodiments, transaction service provider system 108 may be in communication with a data storage device, which may be local or remote to the transaction service provider system 108. In some non-limiting embodiments, transaction service provider system 108 may be capable of receiving information from, storing information in, communicating information to, or searching information stored in a data storage device.

User device 110 may include one or more devices capable of receiving information from and/or communicating information to merchant system 102, issuer system 106, and/or transaction service provider system 108 via network 112. For example, user device 110 may include one or more computing devices, such as one or more computers, one or more portable computers (e.g., tablet computers), one or more mobile devices (e.g., cellular phones, smartphones, wearable devices, such as watches, glasses, lenses, and/or clothing, personal digital assistants (PDAs), and/or the like), and/or other like devices. In some non-limiting embodiments, user device 110 may be capable of receiving information (e.g., from electronic payment card 104) via a short-range wireless communication connection, such as an NFC communication connection, an RFID communication connection, a Bluetooth® communication connection, and/or the like, and/or communicating information (e.g., to electronic payment card 104) via a short range wireless communication connection.

Network 112 may include one or more wired and/or wireless networks. For example, network 112 may include a cellular network (e.g., a long-term evolution (LTE) network, a third generation (3G) network, a fourth generation (4G) network, a code division multiple access (CDMA) network, etc.), a public land mobile network (PLMN), a local area network (LAN), a wide area network (WAN), a metropolitan area network (MAN), a telephone network (e.g., the public switched telephone network (PSTN)), a private network, an ad hoc network, an intranet, the Internet, a fiber optic-based network, a cloud computing network, and/or the like, and/or a combination of these or other types of networks.

The number and arrangement of devices and networks shown in FIG. 1 are provided as an example. There may be additional devices and/or networks, fewer devices and/or networks, different devices and/or networks, or differently arranged devices and/or networks than those shown in FIG. 1. Furthermore, two or more devices shown in FIG. 1 may be implemented within a single device, or a single device shown in FIG. 1 may be implemented as multiple, distributed devices. Additionally or alternatively, a set of devices (e.g., one or more devices) of environment 100 may perform one or more functions described as being performed by another set of devices of environment 100.

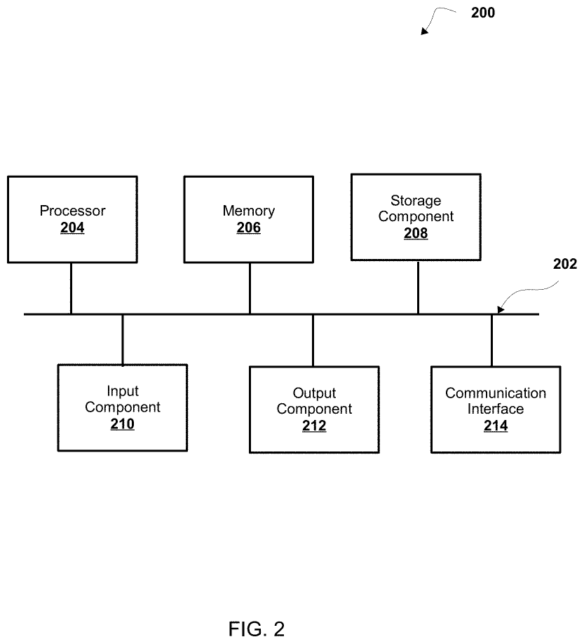

Referring now to FIG. 2, FIG. 2 is a diagram of example components of a device 200. Device 200 may correspond to one or more devices of merchant system 102, electronic payment card 104, one or more devices of issuer system 106, one or more devices of transaction service provider system 108, and/or user device 110. In some non-limiting embodiments, merchant system 102, electronic payment card 104, issuer system 106, transaction service provider system 108, and/or user device 110 may include at least one device 200 and/or at least one component of device 200. As shown in FIG. 2, device 200 may include a bus 202, a processor 204, memory 206, a storage component 208, an input component 210, an output component 212, and a communication interface 214.

Bus 202 may include a component that permits communication among the components of device 200. In some non-limiting embodiments, processor 204 may be implemented in hardware, firmware, or a combination of hardware and software. For example, processor 204 may include a processor (e.g., a central processing unit (CPU), a graphics processing unit (GPU), an accelerated processing unit (APU), etc.), a microprocessor, a digital signal processor (DSP), and/or any processing component (e.g., a field-programmable gate array (FPGA), an application-specific integrated circuit (ASIC), etc.) that can be programmed to perform a function. Memory 206 may include random access memory (RAM), read only memory (ROM), and/or another type of dynamic or static storage device (e.g., flash memory, magnetic memory, optical memory, etc.) that stores information and/or instructions for use by processor 204.

Storage component 208 may store information and/or software related to the operation and use of device 200. For example, storage component 208 may include a hard disk (e.g., a magnetic disk, an optical disk, a magneto-optic disk, a solid state disk, etc.), a compact disc (CD), a digital versatile disc (DVD), a floppy disk, a cartridge, a magnetic tape, and/or another type of computer-readable medium, along with a corresponding drive.

Input component 210 may include a component that permits device 200 to receive information, such as via user input (e.g., a touch screen display, a keyboard, a keypad, a mouse, a button, a switch, a microphone, etc.). Additionally or alternatively, input component 210 may include a sensor for sensing information (e.g., a global positioning system (GPS) component, an accelerometer, a gyroscope, an actuator, etc.). Output component 212 may include a component that provides output information from device 200 (e.g., a display, a display screen, a speaker, one or more light-emitting diodes (LEDs), etc.).

Communication interface 214 may include a transceiver-like component (e.g., a transceiver, a separate receiver and transmitter, etc.) that enables device 200 to communicate with other devices, such as via a wired connection, a wireless connection, or a combination of wired and wireless connections. Communication interface 214 may permit device 200 to receive information from another device and/or provide information to another device. For example, communication interface 214 may include an Ethernet interface, an optical interface, a coaxial interface, an infrared interface, a radio frequency (RF) interface, a universal serial bus (USB) interface, a Wi-Fi® interface, a cellular network interface, and/or the like.

Device 200 may perform one or more processes described herein. Device 200 may perform these processes based on processor 204 executing software instructions stored by a computer-readable medium, such as memory 206 and/or storage component 208. A computer-readable medium (e.g., a non-transitory computer-readable medium) is defined herein as a non-transitory memory device. A memory device includes memory space located inside of a single physical storage device or memory space spread across multiple physical storage devices.

Software instructions may be read into memory 206 and/or storage component 208 from another computer-readable medium or from another device via communication interface 214. When executed, software instructions stored in memory 206 and/or storage component 208 may cause processor 204 to perform one or more processes described herein. Additionally or alternatively, hardwired circuitry may be used in place of or in combination with software instructions to perform one or more processes described herein. Thus, embodiments described herein are not limited to any specific combination of hardware circuitry and software.

The number and arrangement of components shown in FIG. 2 are provided as an example. In some non-limiting embodiments, device 200 may include additional components, fewer components, different components, or differently arranged components than those shown in FIG. 2. Additionally or alternatively, a set of components (e.g., one or more components) of device 200 may perform one or more functions described as being performed by another set of components of device 200.

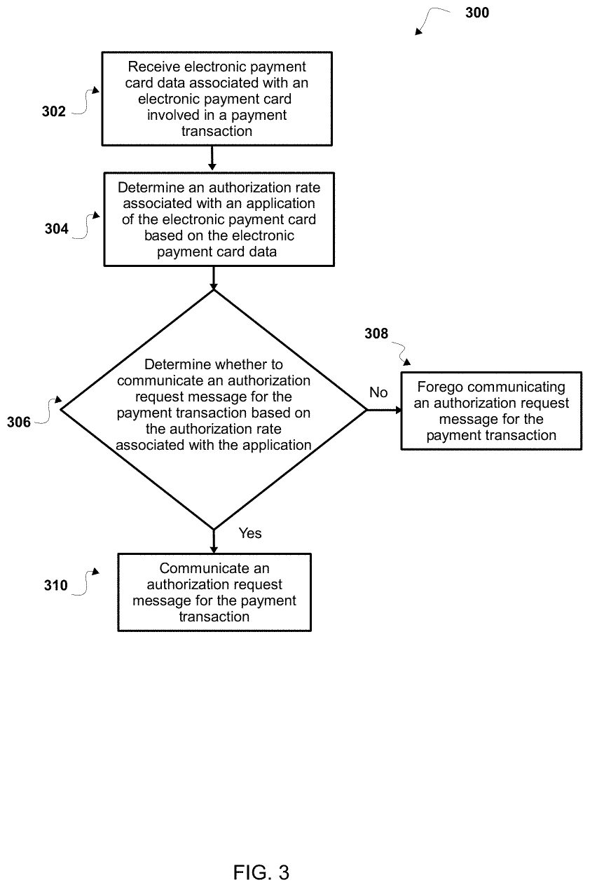

Referring now to FIG. 3, FIG. 3 is a flowchart of a non-limiting embodiment of a process 300 for predicting authorization of a payment transaction conducted using an electronic payment card. In some non-limiting embodiments, one or more of the steps of process 300 may be performed (e.g., completely, partially, etc.) by merchant system 102 (e.g., a POS device of merchant system 102). In some non-limiting embodiments, one or more of the steps of process 300 may be performed (e.g., completely, partially, etc.) by another device or a group of devices separate from merchant system 102, such as electronic payment card 104, issuer system 106 (e.g., one or more devices of issuer system 106), transaction service provider system 108 (e.g., one or more devices of transaction service provider system 108), or user device 110.

As shown in FIG. 3, at step 302, process 300 includes receiving electronic payment card data associated with an electronic payment card involved in a payment transaction. For example, merchant system 102 (e.g., a POS device of merchant system 102) may receive electronic payment card data associated with electronic payment card 104 that is involved in a payment transaction between a user associated with electronic payment card 104 and a merchant associated with merchant system 102. In some non-limiting embodiments, the electronic payment card data associated with electronic payment card 104 may include data associated with an application of electronic payment card 104. For example, the electronic payment card data may include data associated with one or more counters for the application and/or data associated with an identifier of the application of electronic payment card 104.

In some non-limiting embodiments, an application of electronic payment card 104 may include instructions that specify a way in which a payment transaction is to be processed. For example, an application may include a set of instructions that specify that a payment transaction is to be processed based on a type of account (e.g., a credit account, a debit account, and/or the like), a type of repayment plan for an account (e.g., an installments repayment plan), and/or the like. In some non-limiting embodiments, an application may include a credit account application, a debit account application, an installments payment application, and/or the like. In some non-limiting embodiments, an application may be based on an EMV standard and/or a GP standard.

In some non-limiting embodiments, the electronic payment card data may include a total payment network transactions counter, data associated with approved payment network transactions counter, data associated with a declined payment network transactions counter, data associated with a merchant declined transactions counter, data associated with a merchant approved transactions counter, and/or data associated with an application selected counter for an application (e.g., an application of a plurality of applications) of electronic payment card 104. Additionally or alternatively, the electronic payment card data may include data associated with an account identifier of an account associated with electronic payment card 104. For example, the electronic payment card data may include data associated with a PAN, a token, and/or the like, for an account associated with electronic payment card 104. In some non-limiting embodiments, the account identifier of the account associated with electronic payment card 104 may be an account identifier of an account associated with an application of electronic payment card 104.

In some non-limiting embodiments, electronic payment card 104 may store electronic payment card data that includes a plurality of counters for each application of a plurality of applications of electronic payment card 104. For example, electronic payment card 104 may store a total payment network transactions counter, approved payment network transactions counter, a declined payment network transactions counter, a merchant declined transactions counter, a merchant approved transactions counter, and/or an application selected counter for an application (e.g., for an application of a plurality of applications, for each application of the plurality of applications, and/or the like) of electronic payment card 104.

In some non-limiting embodiments, the total payment network transactions counter may include an indication of a number of payment transactions (e.g., for an application) that were communicated to a payment network (e.g., an electronic network associated with a transaction service provider for processing a payment transaction, a payment processing network, a card network, a credit card network, etc.). For example, the total payment network transactions counter may include an indication of a number of authorization request messages for payment transactions that were communicated to transaction service provider system 108 and/or issuer system 106.

In some non-limiting embodiments, the approved payment network transactions counter may include an indication of a number of payment transactions (e.g., for an application) that were approved by an issuer system (e.g., issuer system 106) after the payment transactions were submitted to a payment processing network. For example, the approved payment network transactions counter may include an indication of a number of authorization response messages for payment transactions, which were received in response to authorization request messages, which included an indication that the payment transaction was approved by issuer system 106.

In some non-limiting embodiments, the declined payment network transactions counter includes an indication of a number of payment transactions (e.g., for an application) that were declined by an issuer system (e.g., issuer system 106) after the payment transactions were submitted to a payment processing network. For example, the approved payment network transactions counter may include an indication of a number of authorization response messages for payment transactions, which were received in response to authorization request messages, which included an indication that the payment transactions were declined by issuer system 106.

In some non-limiting embodiments, the merchant declined transactions counter may include an indication of a number of payment transactions (e.g., for an application) that were declined by a merchant system (e.g., merchant system 102) after the merchant system determined an authorization rate associated with an application. For example, the merchant declined transactions counter may include an indication of a number of payment transactions that merchant system 102 determined not to authorize after the merchant system determined an authorization rate associated with an application.

In some non-limiting embodiments, the merchant approved transactions counter may include an indication of a number of payment transactions (e.g., for an application) that were approved by a merchant system (e.g., merchant system 102) after the merchant system determined an application authorization rate of payment network transactions. For example, the merchant approved transactions counter may include an indication of a number of payment transactions that merchant system 102 determined to authorize after merchant system 102 determined the authorization rate associated with the application.

In some non-limiting embodiments, the application selected counter may include an indication of a number of times an application was selected (e.g., by merchant system 102 or by a merchant associated with merchant system 102) for processing a payment transaction. For example, the application selected counter may include an indication of a number of times an application was selected for processing a payment transaction before merchant system 102 determines whether to communicate an authorization request message for the payment transaction based on an authorization rate associated with the application. In another example, the application selected counter may include an indication of a number of times an application was selected for processing a payment transaction after merchant system 102 determines the authorization rate for the application.

In some non-limiting embodiments, the one or more counters for an application may be stored as data elements in a memory of electronic payment card 104. For example, a counter may include a data element from an application elementary file stored in a memory of electronic payment card 104. In some non-limiting embodiments, the length of the data element may be one byte and the 8th bit may be equal to zero.

In some non-limiting embodiments, merchant system 102 may receive the electronic payment card data associated with electronic payment card 104 based on communicating a command (e.g., a GET DATA command, a GET DATA command application protocol data unit (APDU), and/or the like) to electronic payment card 104. For example, merchant system 102 may communicate a command to electronic payment card 104 (e.g., during a payment transaction) and electronic payment card 104 may receive the command. Electronic payment card 104 may retrieve electronic payment card data from a memory of electronic payment card 104 based on receiving the command from merchant system 102. Electronic payment card 104 may communicate the electronic payment card data to merchant system 102 based on retrieving the electronic payment card data from the memory of electronic payment card 104. Merchant system 102 may receive the electronic payment card data after electronic payment card 104 communicates the electronic payment card data. In some non-limiting embodiments, the command to electronic payment card 104 may be based on an APDU (e.g., a smart card APDU) for electronic payment card 104.

In some non-limiting embodiments, electronic payment card 104 may receive the command from merchant system 102 and electronic payment card 104 may communicate the electronic payment card data in a response (e.g., a GET DATA response, a GET DATA response APDU) to merchant system 102. For example, electronic payment card 104 may receive the command from merchant system 102 and electronic payment card 104 may communicate the electronic payment card data in the response to merchant system 102, wherein the response is based on an APDU (e.g., a smart card APDU). In some non-limiting embodiments, merchant system 102 may determine the electronic payment card data from the response received from electronic payment card 104.

In some non-limiting embodiments, merchant system 102 may receive the electronic payment card data associated with electronic payment card 104 based on merchant system 102 determining that an application of electronic payment card 104 is supported by merchant system 102. For example, electronic payment card 104 may communicate data associated with one or more applications of electronic payment card 104 to merchant system 102. In some non-limiting embodiments, data associated with one or more applications of electronic payment card 104 may include one or more identifiers of the one or more applications of electronic payment card 104. Merchant system 102 may determine that merchant system 102 supports the one or more applications (e.g., may be able to process a payment transaction based on the one or more applications) of electronic payment card 104 based on the data associated with the one or more applications of electronic payment card 104. In some non-limiting embodiments, merchant system 102 may determine that merchant system 102 supports the one or more applications of electronic payment card 104 based on the one or more identifiers of the one or more applications. Merchant system 102 may communicate data associated with an indication that merchant system 102 supports the one or more applications to electronic payment card 104. Electronic payment card 104 may communicate the electronic payment card data associated with electronic payment card 104 based on receiving the data associated with the indication that merchant system 102 supports the one or more applications from merchant system 102 and merchant system 102 may receive the electronic payment card data associated with electronic payment card 104.

In some non-limiting embodiments, merchant system 102 may receive a selection of an application of electronic payment card 104 (e.g., an application that is supported by merchant system 102). For example, a POS device of merchant system 102 may display a list of one or more identifiers of one or more applications of electronic payment card 104 to a user via a user interface (UI) on the POS device. Merchant system 102 may receive information identifying a selection of an application based on a user's input to the UI. In some implementations, merchant system 102 may receive the information identifying the selection of the application based on a user selection of a UI element displayed by the UI on a display screen of the POS device. For example, based on the POS device detecting a user interaction with the UI, the POS device may communicate an indication of the user selection to another device (e.g., a server) of merchant system 102. The UI element may correspond to a selected application of the one or more applications. In some non-limiting embodiments, merchant system 102 may automatically make a selection of an application of electronic payment card 104 and merchant system 102 may receive information identifying the selection of the application based on automatically making the selection of the application. In some non-limiting embodiments, merchant system 102 may automatically make a selection of an application of electronic payment card 104 based on determining that merchant system 102 supports the application.

In some non-limiting embodiments, merchant system 102 may receive the electronic payment card data associated with electronic payment card 104 based on receiving a selection of an application of electronic payment card 104. For example, merchant system 102 may initiate a payment transaction associated with the application based on receiving the selection of the application. Merchant system 102 (e.g., a POS device of merchant system 102) may read the electronic payment card data associated with electronic payment card 104 from a memory of electronic payment card 104 and merchant system 102 may receive the electronic payment card data associated with electronic payment card 104 based on reading the electronic payment card data.

As further shown in FIG. 3, at step 304, process 300 includes determining an authorization rate associated with an application of the electronic payment card based on the electronic payment card data associated with the electronic payment card. For example, merchant system 102 (e.g., a POS device of merchant system 102) may determine the authorization rate associated with the application of the electronic payment card 104 based on the electronic payment card data associated with electronic payment card 104.

In some non-limiting embodiments, the authorization rate associated with the application may include an application authorization rate of payment network transactions for the application and/or a merchant authorization rate of payment network transactions for the application. The application authorization rate of payment network transactions for the application may include an application approved rate of payment network transactions for the application and/or an application declined rate of payment network transactions for the application. The merchant authorization rate of payment network transactions for the application may include a merchant declined rate of payment network transactions for the application or a merchant approved rate of payment network transactions for the application.

In some non-limiting embodiments, merchant system 102 may determine an application authorization rate of payment network transactions for an application. For example, merchant system 102 may determine an application approved rate of payment network transactions for the application by dividing the approved payment network transactions counter for the application by the total payment network transactions counter for the application. In another example, merchant system 102 may determine an application declined rate of payment network transactions for the application by dividing the declined payment network transactions counter for the application by the total payment network transactions counter for the application.

Additionally or alternatively, merchant system 102 may determine the merchant authorization rate of payment network transactions for an application. For example, merchant system 102 may determine the merchant declined rate of payment network transactions for the application by dividing the merchant declined transactions counter for the application by the application selected counter for the application. In another example, merchant system 102 may determine the merchant approved rate of payment network transactions for the application by dividing the merchant approved transactions counter for the application by the application selected counter for the application.

In some non-limiting embodiments, merchant system 102 may display the application authorization rate of payment network transactions for an application and/or the merchant authorization rate of payment network transactions for the application. For example, merchant system 102 may display the application authorization rate of payment network transactions for the application and/or the merchant authorization rate of payment network transactions for the application on a display screen of a POS device of merchant system 102. In some non-limiting embodiments, merchant system 102 may display the application authorization rate of payment network transactions for the application based on determining the application authorization rate of payment network transactions for the application. Additionally or alternatively, merchant system 102 may display the merchant authorization rate of payment network transactions for the application based on determining the merchant authorization rate of payment network transactions for an application.

In some non-limiting embodiments, merchant system 102 may select an application of electronic payment card 104 for processing a payment transaction. For example, merchant system 102 may select an application for processing a payment transaction based on determining that the application is supported by merchant system 102. In another example, merchant system 102 may select an application for processing a payment transaction based on an authorization rate associated with the application.

In some non-limiting embodiments, merchant system 102 may select an application of electronic payment card 104 for processing a payment transaction based on whether the application authorization rate of payment network transactions and/or the merchant authorization rate of payment network transactions for the application satisfies a threshold. For example, merchant system 102 may compare the application authorization rate of payment network transactions and/or the merchant authorization rate of payment network transactions for the application to the threshold to determine if the application authorization rate of payment network transactions and/or the merchant authorization rate of payment network transactions for the application satisfies the threshold. If merchant system 102 determines that the application authorization rate of payment network transactions and/or the merchant authorization rate of payment network transactions for the application satisfies the threshold, merchant system 102 may select the application for processing the payment transaction. If merchant system 102 determines that the application authorization rate of payment network transactions and/or the merchant authorization rate of payment network transactions for the application does not satisfy the threshold, merchant system 102 may not select the application for processing the payment transaction.

In some non-limiting embodiments, merchant system 102 may determine the application authorization rate of payment network transactions for an application and/or the merchant authorization rate of payment network transactions for the application based on merchant system 102 selecting the application for processing a payment transaction. For example, merchant system 102 may select an application of a plurality of applications based on determining that the application is supported by merchant system 102. Merchant system 102 may determine the application authorization rate of payment network transactions for the application and/or the merchant authorization rate of payment network transactions for the application based on merchant system 102 selecting the application.

As further shown in FIG. 3, at step 306, process 300 includes determining whether to communicate an authorization request message for the payment transaction based on the authorization rate associated with the application. For example, merchant system 102 (e.g., a POS device of merchant system 102) may determine whether to communicate an authorization request message (e.g., an authorization request message according to ISO 8583 standard) for the payment transaction based on the authorization rate associated with the application. In some non-limiting embodiments, an authorization request message may include an account identifier of an account associated with an application of electronic payment card 104. In some non-limiting embodiments, merchant system 102 may determine whether to communicate the authorization request message for the payment transaction based on an application of electronic payment card 104. For example, merchant system 102 may determine whether to communicate an authorization request message for the payment transaction based on the application authorization rate of payment network transactions and/or the merchant authorization rate of payment network transactions for an application.

In some non-limiting embodiments, merchant system 102 may determine whether to communicate an authorization request message for the payment transaction based on whether the application authorization rate of payment network transactions and/or the merchant authorization rate of payment network transactions for the application satisfy a threshold. For example, merchant system 102 may compare the application authorization rate of payment network transactions and/or the merchant authorization rate of payment network transactions for the application to the threshold to determine if the application authorization rate of payment network transactions and/or the merchant authorization rate of payment network transactions for the application satisfies the threshold. If merchant system 102 determines that the application authorization rate of payment network transactions and/or the merchant authorization rate of payment network transactions for the application satisfies the threshold, merchant system 102 may determine to communicate the authorization request message for the payment transaction. If merchant system 102 determines that the application authorization rate of payment network transactions and/or the merchant authorization rate of payment network transactions for the application does not satisfy the threshold, merchant system 102 may determine not to communicate the authorization request message for the payment transaction. In some non-limiting embodiments, merchant system 102 may determine not to authorize (e.g., to decline) the payment transaction based on determining not to communicate the authorization request message for the payment transaction.

In some non-limiting embodiments, merchant system 102 may determine whether to communicate an authorization request message for the payment transaction based on a user input. For example, merchant system 102 may determine whether to communicate an authorization request message for the payment transaction based on a user input received via a POS device (e.g., via a UI element displayed by a UI on a display screen of a POS device) of merchant system 102. In such an example, if the user input received via the POS device of merchant system 102 includes an indication to proceed with communicating the authorization request message for the payment transaction, merchant system 102 may determine to communicate the authorization request message for the payment transaction. If the user input received via the POS device of merchant system 102 includes an indication not to proceed with communicating the authorization request message for the payment transaction, merchant system 102 may determine not to communicate the authorization request message for the payment transaction.

In some non-limiting embodiments, merchant system 102 may determine whether to communicate an authorization request message for the payment transaction based on a response received from electronic payment card 104. For example, merchant system 102 may communicate a request message to electronic payment card 104 based on determining the application authorization rate of payment network transactions and/or the merchant authorization rate of payment network transactions for an application. In some non-limiting embodiments, the request message may include the application authorization rate of payment network transactions and/or the merchant authorization rate of payment network transactions for the application. Electronic payment card 104 may determine the response based on the request message. For example, electronic payment card 104 may determine the response based on the application authorization rate of payment network transactions and/or the merchant authorization rate of payment network transactions for the application included in the request message. In some non-limiting embodiments, the response may include an indication to communicate an authorization request message for the payment transaction, an indication not to communicate an authorization request message for the payment transaction and not to authorize the payment transaction, or an indication to authorize (e.g., to approve) the payment transaction independent of (e.g., without) communicating an authorization request message. Electronic payment card 104 may communicate the response to merchant system 102 and merchant system 102 may receive the response and determine whether to communicate an authorization request message for the payment transaction based on a response from electronic payment card 104. For example, electronic payment card 104 may communicate the response to merchant system 102 that includes an indication to communicate an authorization request message for the payment transaction, an indication not to communicate an authorization request message for the payment transaction and not to authorize the payment transaction, or an indication to authorize the payment transaction independent of communicating an authorization request message. Merchant system 102 may receive the response and determine to communicate an authorization request message for the payment transaction based on determining that the response includes an indication to communicate an authorization request message for the payment transaction. Alternatively, merchant system 102 may receive the response and determine not to communicate an authorization request message for the payment transaction based on determining that the response includes an indication not to communicate an authorization request message for the payment transaction and not to authorize the payment transaction or an indication to authorize the payment transaction independent of communicating an authorization request message.

In some non-limiting embodiments, merchant system 102 may determine not to communicate an authorization request message for the payment transaction based on the application authorization rate of payment network transactions and/or the merchant authorization rate of payment network transactions for the application satisfying a threshold. For example, merchant system 102 may determine that the application authorization rate of payment network transactions and/or the merchant authorization rate of payment network transactions for the application satisfies the threshold and merchant system 102 may determine to authorize the payment transaction and not to communicate an authorization request message for the payment transaction. In another example, For example, merchant system 102 may determine that the application authorization rate of payment network transactions and/or the merchant authorization rate of payment network transactions for the application does not satisfy the threshold and merchant system 102 may determine not to authorize the payment transaction and not to communicate an authorization request message for the payment transaction.

In some non-limiting embodiments, merchant system 102 may determine to communicate an authorization request message for the payment transaction based on selecting an application for processing the payment transaction. For example, merchant system 102 may determine an application authorization rate of payment network transactions for the application and/or a merchant authorization rate of payment network transactions for the application. Merchant system 102 may select the application for processing the payment transaction based on the application authorization rate of payment network transactions for the application and/or the merchant authorization rate of payment network transactions for the application satisfying a threshold. Merchant system 102 may determine to communicate the authorization request message for the payment transaction based on selecting the application for processing the payment transaction. In some non-limiting embodiments, the authorization may include an account identifier, stored on electronic payment card 104, of an account associated with the application.

As further shown in FIG. 3, at step 308 (“No”), process 300 includes foregoing communicating an authorization request message for the payment transaction. For example, merchant system 102 (e.g., a POS device of merchant system 102) may forego communicating the authorization request message for the payment transaction based on determining not to communicate the authorization request message. In some non-limiting embodiments, merchant system 102 may forego communicating the authorization request message and determine to authorize the payment transaction. For example, merchant system 102 may forego communicating the authorization request message based on determining not to communicate the authorization request message for the payment transaction and may determine to authorize the payment transaction based on determining that the application authorization rate of payment network transactions and/or the merchant authorization rate of payment network transactions for an application satisfies a threshold. In some non-limiting embodiments, merchant system 102 may display an indication that the payment transaction is authorized based on determining to authorize the payment transaction.

In some non-limiting embodiments, merchant system 102 may forego communicating the authorization request message and determine not to authorize the payment transaction. For example, merchant system 102 may forego communicating the authorization request message based on determining not to communicate the authorization request message for the payment transaction and may determine not to authorize the payment transaction based on determining that the application authorization rate of payment network transactions and/or the merchant authorization rate of payment network transactions for an application does not satisfy a threshold. In some non-limiting embodiments, merchant system 102 may display an indication that the payment transaction is not authorized based on determining not to authorize the payment transaction.

In some non-limiting embodiments, merchant system 102 may determine an application of electronic payment card 104 that is supported by merchant system 102 for processing of the payment transaction based on determining to forego communicating an authorization request message for the payment transaction, foregoing communicating the authorization request message for the payment transaction, and/or determining not to authorize the payment transaction. For example, merchant system 102 may determine to forego communicating an authorization request message for the payment transaction, forego communicating the authorization request message for the payment transaction, and/or determine not to authorize the payment transaction based on a rate associated with a first application of electronic payment card 104 (based on an application authorization rate of payment network transactions for a first application and/or the merchant authorization rate of payment network transactions for a first application of electronic payment card 104). Merchant system 102 may determine a second application of electronic payment card 104 that is supported by merchant system 102 after determining to forego communicating an authorization request message for the payment transaction, foregoing communicating the authorization request message for the payment transaction, and/or determining not to authorize the payment transaction. In some non-limiting embodiments, merchant system 102 may determine whether to communicate an authorization request message for the payment transaction based on the authorization rate associated with the second application in the same or similar way as described herein.

As further shown in FIG. 3, at step 310 (“Yes”), process 300 includes communicating an authorization request message for the payment transaction. For example, merchant system 102 (e.g., a POS device of merchant system 102) may communicate an authorization request message (e.g., an authorization request message according to ISO 8583 standard) for the payment transaction to transaction service provider system 108 and/or issuer system 106. In some non-limiting embodiments, merchant system 102 may communicate the authorization request message and determine whether to authorize the payment transaction based on a response to the authorization request message. For example, merchant system 102 may communicate the authorization request message to transaction service provider system 108 and/or issuer system 106 and merchant system 102 may determine to authorize or not to authorize the payment transaction based on an authorization response message (e.g., an authorization response message according to ISO 8583 standard) communicated by issuer system 106 based on the authorization request message (e.g., in response to the authorization request message). The authorization response message may be communicated by issuer system 106 to transaction service provider system 108 and transaction service provider system 108 may communicate the authorization response message to merchant system 102. Merchant system 102 may determine whether to authorize the payment transaction based on the authorization response message received by merchant system 102. In some non-limiting embodiments, merchant system 102 may display an indication that the payment transaction is authorized based on determining to authorize the payment transaction. In some non-limiting embodiments, merchant system 102 may determine not to authorize the payment transaction based on a response to the authorization request message. In some non-limiting embodiments, merchant system 102 may display an indication that the payment transaction is not authorized based on determining not to authorize the payment transaction. In some non-limiting embodiments, the authorization response message may include an indication that an issuer (e.g., an issuer associated with issuer system 106) that issued an account associated with electronic payment card 104 authorizes the payment transaction or an indication that the issuer that issued the account associated with electronic payment card 104 does not authorize the payment transaction.

In some non-limiting embodiments, merchant system 102 may update (e.g., increase, decrease, increment, decrement, and/or the like) a counter for an application of electronic payment card 104. For example, merchant system 102 (e.g., a POS device of merchant system 102) may communicate a script to electronic payment card 104 that causes electronic payment card 104 to update one or more counters (e.g., all of the counters) for the application of electronic payment card 104. In some non-limiting embodiments, the script may cause an integrated circuit of electronic payment card 104 to update the counter for the application of electronic payment card 104. In some non-limiting embodiments, the script includes one or more commands to update the one or more counters for the application of electronic payment card 104. In some non-limiting embodiments, the script may be provided by an issuer (e.g., an issuer that issued an account associated with electronic payment card 104). In some non-limiting embodiments, the script may be included in an authorization response message communicated by transaction service provider system 108 and/or issuer system 106.

In some non-limiting embodiments, merchant system 102 may communicate a script to electronic payment card 104 that causes electronic payment card 104 to update a total payment network transactions counter, approved payment network transactions counter, a declined payment network transactions counter, a merchant declined transactions counter, a merchant approved transactions counter, and/or an application selected counter for an application (e.g., an application of a plurality of applications, each application of a plurality of applications, and/or the like) of electronic payment card 104.

In some non-limiting embodiments, merchant system 102 may communicate a script to electronic payment card 104 that causes electronic payment card 104 to update the total payment network transactions counter for an application based on merchant system 102 communicating an authorization request message for a payment transaction to transaction service provider system 108 and/or issuer system 106. In some non-limiting embodiments, merchant system 102 may communicate a script to electronic payment card 104 that causes electronic payment card 104 to update the approved payment network transactions counter for an application based on merchant system 102 receiving an authorization response messages for a payment transaction (e.g., received in response to an authorization request message communicated by merchant system 102) from transaction service provider system 108 and/or issuer system 106, that includes an indication that the payment transaction was approved by issuer system 106. In some non-limiting embodiments, merchant system 102 may communicate a script to electronic payment card 104 that causes electronic payment card 104 to update a declined payment network transactions counter for an application based on merchant system 102 receiving an authorization response messages for a payment transaction (e.g., received in response to an authorization request message communicated by merchant system 102) from transaction service provider system 108 and/or issuer system 106, that includes an indication that the payment transaction was declined by issuer system 106. In some non-limiting embodiments, merchant system 102 may communicate a script to electronic payment card 104 that causes electronic payment card 104 to update a merchant declined transactions counter for an application based on merchant system 102 determining to decline a payment transaction after merchant system 102 determines an authorization rate associated with the application. In some non-limiting embodiments, merchant system 102 may communicate a script to electronic payment card 104 that causes electronic payment card 104 to update a merchant approved transactions counter for an application based on merchant system 102 determining to authorize a payment transaction after merchant system 102 determines an authorization rate associated with the application. In some non-limiting embodiments, merchant system 102 may communicate a script to electronic payment card 104 that causes electronic payment card 104 to update an application selected counter for an application based on merchant system 102 selecting the application for processing a payment transaction.

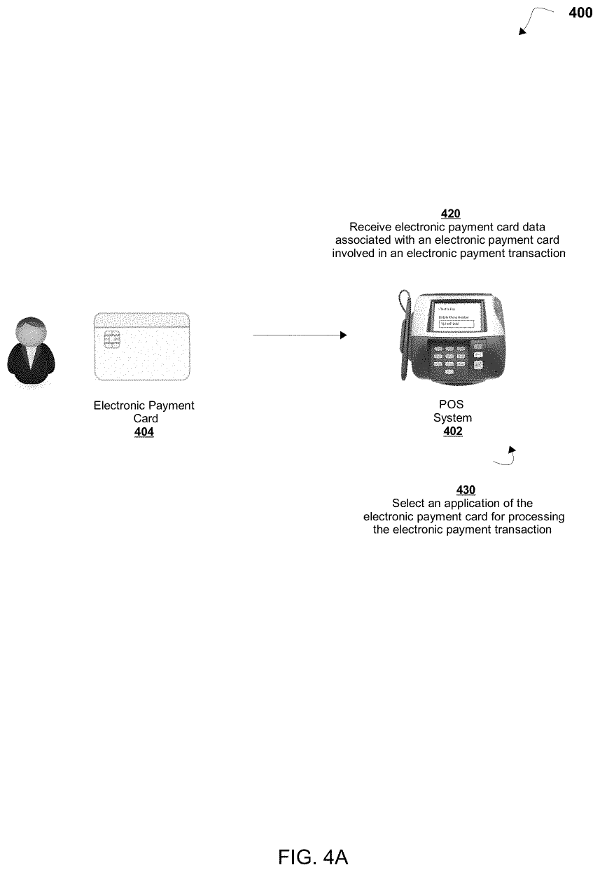

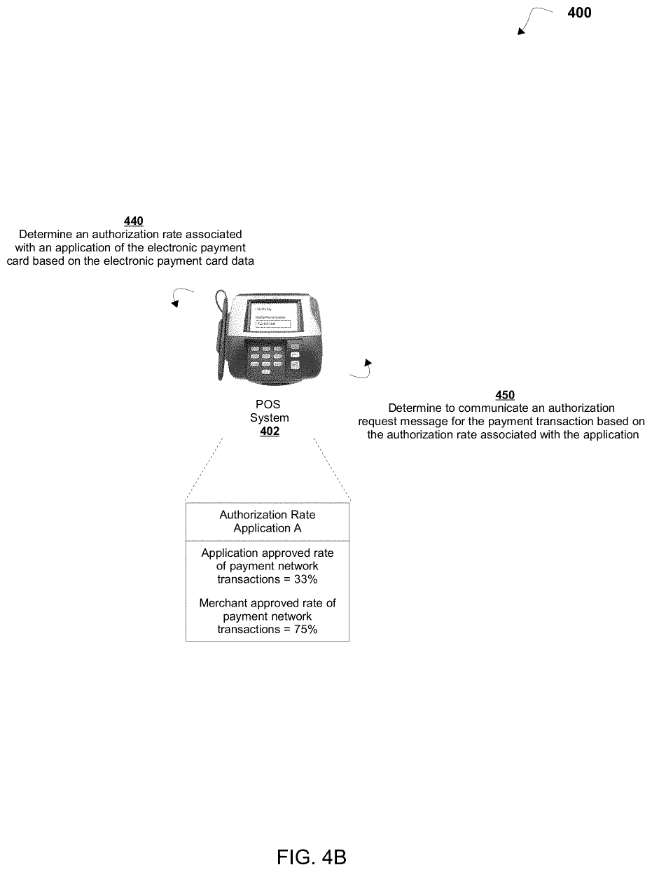

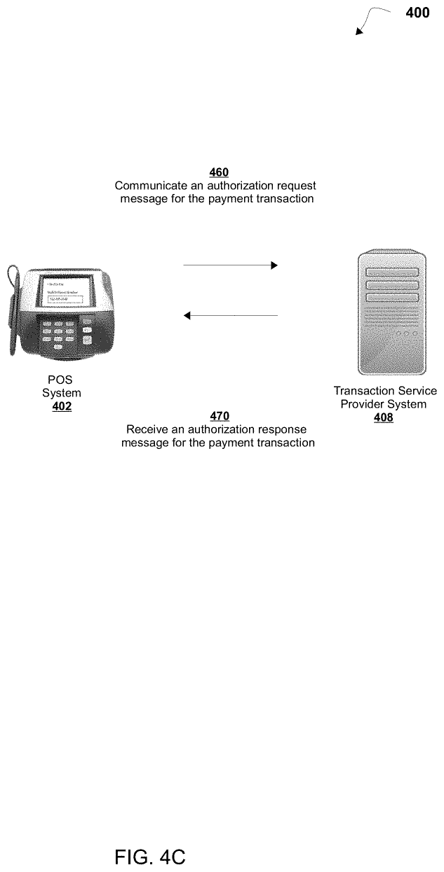

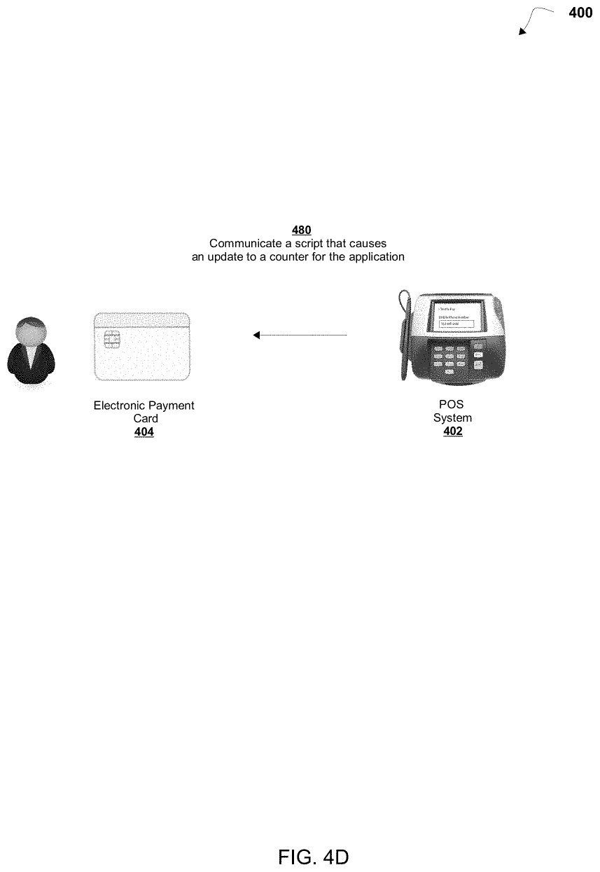

FIGS. 4A-4D are diagrams of an overview of a non-limiting embodiment of an implementation 400 relating to process 300 shown in FIG. 3. As shown in FIGS. 4A-4D, implementation 400 may include point-of-sale (POS) system 402, electronic payment card 404, and transaction service provider system 408. In some non-limiting embodiments, POS system 402 may be the same or similar to merchant system 102, electronic payment card 404 may be the same or similar to electronic payment card 104, and/or transaction service provider system 408 may be the same or similar to transaction service provider system 108.

As shown by reference number 420 in FIG. 4A, POS system 402 may receive electronic payment card data associated with an electronic payment card involved in a payment transaction from electronic payment card 404. In some non-limiting embodiments, the electronic payment card data associated with electronic payment card 404 may include data associated with an application of electronic payment card 404. For example, the electronic payment card data may include data associated with a total payment network transactions counter, data associated with approved payment network transactions counter, data associated with a declined payment network transactions counter, data associated with a merchant declined transactions counter, data associated with a merchant approved transactions counter, and/or data associated with an application selected counter for an application of electronic payment card 404. As further shown by reference number 430 in FIG. 4A, POS system 402 may select an application of electronic payment card 404 for processing the payment transaction. For example, POS system 402 may select an application of electronic payment card 404 based on determining that the application is supported by POS system 402. In another example, POS system 402 may select an application for processing a payment transaction based on an authorization rate associated with the application.

As shown by reference number 440 in FIG. 4B, POS system 402 may determine an authorization rate associated with an application of the electronic payment card based on the electronic payment card data. For example, POS system 402 may determine an application authorization rate of payment network transactions for the application and/or a merchant authorization rate of payment network transactions for the application. In some non-limiting embodiments, the application authorization rate of payment network transactions for the application may include an application approved rate of payment network transactions for the application and/or an application declined rate of payment network transactions for the application. In some non-limiting embodiments, the merchant authorization rate of payment network transactions for the application may include a merchant declined rate of payment network transactions for the application or a merchant approved rate of payment network transactions for the application. In some non-limiting embodiments, POS system 402 may display the authorization rate associated with the application of electronic payment card 404 on a display screen of POS system 402. For example, POS system 402 may display the application authorization rate of payment network transactions for the application and/or the merchant authorization rate of payment network transactions for the application on a display screen of POS system 402.

As further shown by reference number 450 in FIG. 4B, POS system 402 may determine to communicate an authorization request message for the payment transaction based on the authorization rate associated with the application. For example, POS system 402 may determine to communicate the authorization request message for the payment transaction based on the application authorization rate of payment network transactions for the application and/or the merchant authorization rate of payment network transactions for the application satisfying a threshold.

As shown by reference number 460 in FIG. 4C, POS system 402 may communicate an authorization request message for the payment transaction to transaction service provider system 408. As further shown by reference number 470 in FIG. 4C, POS system 402 may receive an authorization response message for the payment transaction from transaction service provider system 408 based on the authorization request message for the payment transaction. As shown by reference number 480 in FIG. 4D, POS system 402 may communicate a script that causes an update to a counter for the application of electronic payment card 404. For example, POS system 402 may communicate the script to electronic payment card 404 that causes electronic payment card 404 to update a total payment network transactions counter, approved payment network transactions counter, a declined payment network transactions counter, a merchant declined transactions counter, a merchant approved transactions counter, and/or an application selected counter for an application of electronic payment card 404.

Some non-limiting embodiments are described herein as being associated with thresholds. As used herein, satisfying a threshold may refer to a value being greater than the threshold, more than the threshold, higher than the threshold, greater than or equal to the threshold, less than the threshold, fewer than the threshold, lower than the threshold, less than or equal to the threshold, equal to the threshold, and/or the like.

Some non-limiting embodiments of user interfaces (U Is) have been described herein and/or shown in the figures. A UI may include a graphical user interface (GUI), a non-graphical user interface, a text-based user interface, etc. A UI may provide information for display. In some implementations, a user may interact with the information, such as by providing input via an input component of a device that provides the UI for display. In some implementations, a UI may be configurable by a device and/or a user (e.g., a user may change the size of the UI, information provided via the UI, a position of information provided via the UI, etc.). Additionally or alternatively, a UI may be pre-configured to a standard configuration, a specific configuration based on a type of device on which the UI is displayed, and/or a set of configurations based on capabilities and/or specifications associated with a device on which the UI is displayed.

Although the disclosure has been described in detail for the purpose of illustration based on what is currently considered to be the most practical and preferred embodiments, it is to be understood that such detail is solely for that purpose and that the disclosure is not limited to the disclosed embodiments, but, on the contrary, is intended to cover modifications and equivalent arrangements that are within the spirit and scope of the appended claims. For example, it is to be understood that the present disclosure contemplates that, to the extent possible, one or more features of any embodiment can be combined with one or more features of any other embodiment.

What is claimed is:

1. A system for predicting authorization of a payment transaction comprising:
at least one processor programmed or configured to:
receive electronic payment card data associated with an electronic payment card involved in a payment transaction;
determine an authorization rate associated with an application of the electronic payment card based on the electronic payment card data associated with the electronic payment card;
determine whether to communicate an authorization request message for the payment transaction based on the authorization rate associated with the application of the electronic payment card;
communicate the authorization request message based on determining to communicate the authorization request; and
determine to authorize the payment transaction based on an authorization response message.

2. The system of claim 1, wherein the at least one processor is further programmed or configured to:
update a counter for the application of the electronic payment card, wherein the counter is stored on the electronic payment card.

3. The system of claim 2, wherein, when updating the counter for the application of the electronic payment card, the at least one processor is programmed or configured to:
communicate a script to the electronic payment card that causes an integrated circuit of the electronic payment card to update the counter for the application of the electronic payment card.

4. The system of claim 1, wherein, when determining the authorization rate associated with the application of the electronic payment card, the at least one processor is programmed or configured to:
determine an application authorization rate of payment network transactions for the application and a merchant authorization rate of payment network transactions for the application based on the electronic payment card data associated with the electronic payment card; and
wherein, when determining whether to communicate the authorization request message for the payment transaction, the at least one processor is programmed or configured to:
determine to communicate the authorization request message for the payment transaction based on the application authorization rate of payment network transactions for the application and the merchant authorization rate of payment network transactions for the application.

5. The system of claim 1, wherein, when receiving the electronic payment card data associated with the electronic payment card involved in the payment transaction, the at least one processor is programmed or configured to:
receive the electronic payment card data associated with the electronic payment card involved in the payment transaction from an integrated circuit of the electronic payment card.

6. The system of claim 1, wherein the electronic payment card data comprises data associated with a plurality of counters for the application of the electronic payment card data, and wherein, when determining whether to communicate the authorization request message for the payment transaction, the at least one processor is programmed or configured to:
determine the authorization rate associated with the application of the electronic payment card based on the plurality of counters for the application.

7. The system of claim 1, wherein the at least one processor is further programmed or configured to:
select the application of the electronic payment card based on determining that the application of the electronic payment card is supported by a point-of-sale (POS) device of a merchant system; and
wherein, when determining the authorization rate associated with the application of the electronic payment card, the at least one processor is programmed or configured to:
determine the authorization rate associated with the application of the electronic payment card based on selecting the application of the electronic payment card.

8. A computer program product for predicting authorization of a payment transaction, the computer program product comprising at least one non-transitory computer-readable medium including one or more instructions that, when executed by at least one processor, cause the at least one processor to:
receive electronic payment card data associated with an electronic payment card involved in a payment transaction;
determine an authorization rate associated with an application of the electronic payment card based on the electronic payment card data associated with the electronic payment card;
determine whether to communicate an authorization request message for the payment transaction based on the authorization rate associated with the application of the electronic payment card; and
communicate the authorization request message based on determining that the authorization rate associated with the application of the electronic payment card satisfies a threshold.

9. The computer program product of claim 8, wherein the one or more instructions further cause the at least one processor to:
update a counter for the application of the electronic payment card, wherein the counter is stored on the electronic payment card.

10. The computer program product of claim 9, wherein the one or more instructions that cause the at least one processor to update the counter for the application of the electronic payment card, cause the at least one processor to:
communicate a script to the electronic payment card that causes an integrated circuit of the electronic payment card to update the counter for the application of the electronic payment card.

11. The computer program product of claim 8, wherein the one or more instructions that cause the at least one processor to determine the authorization rate associated with the application of the electronic payment card, cause the at least one processor to:
determine an application authorization rate of payment network transactions for the application and a merchant authorization rate of payment network transactions for the application based on the electronic payment card data associated with the electronic payment card; and
wherein the one or more instructions that cause the at least one processor to determine whether to communicate the authorization request message for the payment transaction, cause the at least one processor to:
determine to communicate the authorization request message for the payment transaction based on the application authorization rate of payment network transactions for the application and the merchant authorization rate of payment network transactions for the application.

12. The computer program product of claim 8, wherein the one or more instructions that cause the at least one processor to receive the electronic payment card data associated with the electronic payment card involved in the payment transaction, cause the at least one processor to:
receive the electronic payment card data associated with the electronic payment card involved in the payment transaction from an integrated circuit of the electronic payment card.

13. The computer program product of claim 8, wherein the electronic payment card data comprises data associated with a plurality of counters for the application of the electronic payment card data, and wherein the one or more instructions that cause the at least one processor to determine whether to communicate the authorization request message for the payment transaction, cause the at least one processor to:
determine the authorization rate associated with the application of the electronic payment card based on the plurality of counters for the application.

14. A computer-implemented method for predicting authorization of a payment transaction comprising:
receiving, with at least one processor, electronic payment card data associated with an electronic payment card involved in a payment transaction;
determining, with at least one processor, an authorization rate associated with an application of the electronic payment card based on the electronic payment card data associated with the electronic payment card;
determining, with at least one processor, whether to communicate an authorization request message for the payment transaction based on the authorization rate associated with the application of the electronic payment card;
communicating, with at least one processor, the authorization request message based on determining that the authorization rate associated with the application of the electronic payment card satisfies a threshold; and
determining, with at least one processor, to authorize the payment transaction based on an authorization response message.

15. The computer-implemented method of claim 14, further comprising:
updating a counter for the application of the electronic payment card, wherein the counter is stored on the electronic payment card.

16. The computer-implemented method of claim 15, wherein updating the counter for the application of the electronic payment card comprises:
communicating a script to the electronic payment card that causes an integrated circuit of the electronic payment card to update the counter for the application of the electronic payment card.

17. The computer-implemented method of claim 14, wherein determining, the authorization rate associated with the application of the electronic payment card comprises:
determining an application authorization rate of payment network transactions for the application and a merchant authorization rate of payment network transactions for the application based on the electronic payment card data associated with the electronic payment card; and
wherein determining whether to communicate the authorization request message for the payment transaction comprises:
determining to communicate the authorization request message for the payment transaction based on the application authorization rate of payment network transactions for the application and the merchant authorization rate of payment network transactions for the application.

18. The computer-implemented method of claim 14, wherein receiving the electronic payment card data associated with the electronic payment card involved in the payment transaction comprises:
receiving the electronic payment card data associated with the electronic payment card involved in the payment transaction from an integrated circuit of the electronic payment card.

19. The computer-implemented method of claim 14, wherein the electronic payment card data comprises data associated with a plurality of counters for the application of the electronic payment card data, and wherein determining whether to communicate the authorization request message for the payment transaction comprises:
determining the authorization rate associated with the application of the electronic payment card based on the plurality of counters for the application.

20. The computer-implemented method of claim 14, further comprising:
selecting the application of the electronic payment card based on determining that the application of the electronic payment card is supported by a point-of-sale (POS) device of a merchant system; and
wherein determining the authorization rate associated with the application of the electronic payment card comprises:
determining the authorization rate associated with the application of the electronic payment card based on selecting the application of the electronic payment card.
